(19) United States
(12) Patent Application Publication
(10) Pub. No.: US 2008/0008246 A1
(43) Pub. Date: Jan. 10, 2008

(54) Optimizing video coding

(76) Inventors: Debargha Mukherjee, Sunnyvale, CA (US); Huisheng Wang, San Diego, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/481,366

(22) Filed: Jul. 5, 2006

(51) Int. Cl. H04N 11/04

(52) U.S. Cl. 375/240.18; 375/240.24

(57) ABSTRACT

Video coding includes one-stage coding a data block of video data using a first transform and two-stage coding the data block using a second direction-adaptive transform and the first transform. A first number of bits used to code the data block for the one-stage coding and a distortion are determined, and a second number of bits used to code the data block for the two-stage coding and a distortion are determined. The one-stage coding or the two-stage coding is selected to code the data block based on the distortion and the number of bits used to code the data block.

### BACKGROUND

Block-based hybrid video coding is the core of current video coding standards, and effectively combines motion-compensated temporal prediction (MCP) and transform coding. Generally, for block-based hybrid video coding, each video frame is divided into macroblocks (MB), with each MB corresponding to a 16×16 pixel region of the frame. MBs may be intracoded or intercoded. An interceded MB is first predicted from a number of previously reconstructed reference frames, which may include intracoded reference frames, using block-based motion estimation. H.264, MPEG-4, and advanced video coding (AVC) are examples of video coding standards that use motion compensation.

After prediction, the residual block is transformed, for example, using either a 4×4 or 8×8 transform, quantized and then finally coded by variable-length entropy coding (VLC). The transform provides for image and video compression. The transform is applied to exploit the spatial correlation among pixels, and most of the energy in the transform data is concentrated into a small number of values. The transforms may convert a signal from the time domain to the frequency domain to perform filtering for compression.

Currently, the most popular transforms for this purpose are block-based discrete cosine transforms (DCTs) adopted in most video coding standards, and the discrete wavelet transform, which are image-based, in JPEG2000 image coding. Compared with wavelets, the block-based DCT transform is more often used in practice due to its simplicity and low-memory requirements. Moreover, it fits well with the block-based motion compensation in video coding.

Despite the popularity of DCT and wavelets, the may not provide a good quality two-dimensional representation for images that consist of piecewise smooth regions, separated by smooth boundaries. For example, using wavelets for compression, a smooth boundary between a moving object in a frame and a non-moving background in the frame may appear jagged when the image in the frame is reconstructed. Also, neither wavelets nor DCT can characterize the smoothness along the edge or boundary efficiently. Ridgelets are another type of known transform that may provide a better good quality two-dimensional representation for images that consist of piecewise smooth regions. However, ridgelets may not be as efficient in compressing images.

### BRIEF DESCRIPTION OF THE DRAWINGS

Various features of the embodiments can be more fully appreciated, as the same become better understood with reference to the following detailed description of the embodiments when considered in connection with the accompanying figures, in which:

FIG. 1 illustrates a two-stage encoder, according to an embodiment;

FIG. 2 illustrates an encoding system, according to an embodiment;

FIG. 3 illustrates a flow chart of a method for coding video data, according to an embodiment;

FIG. 4 illustrates a flow chart of a method for two-stage coding video data, according to an embodiment; and

FIG. 5 illustrates a computer system, according to an embodiment.

### DETAILED DESCRIPTION

For simplicity and illustrative purposes, the principles of the embodiments are described and references are made to the accompanying figures.

According to an embodiment, two-stage coding may be used to code video data. The video data may be comprised of data blocks. A data block is a sample of video data. In one example, the sample may be a portion of a frame, such as an n×n block of pixels. One example of a data block in a frame is a MB. The data blocks may include video data in an inter-coded frame generated through motion compensation, referred to as a residual frame, and the data blocks may be coded using a video coding standard, such as H.264, MPEG-4 or AVC. The embodiments described herein are applicable to coding video and still images by way of example and not limitation. Video data as used herein may encompass both video and still images.

Two-stage coding comprises compressing and coding the data blocks. Compression for the two-stage coding may include applying two different transforms to the data blocks of video data. For example, in a first coding stage, one transform is applied, and in a second stage, another transform is applied. In one embodiment, a direction-adaptive transform is applied in a first coding stage to identify and transform any portions of a data block that represent a directional component.

A directional component comprises two-dimensional piecewise smooth signals in an image represented by the data block. Directional components are commonly found in residual frames but may also be found in intracoded frames. For example, a directional component may include a smooth boundary between a moving object in a residual frame and a non-moving background in the residual frame. The DCT transform (block-based) and the discrete wavelet transform (image-based are popular transforms for coding video. Despite the popularity of DCT and wavelets, they are not good at two-dimensional representation for images that consist of piecewise smooth regions, separated by smooth boundaries. Wavelets in two dimensions are obtained as a tensor product of one-dimensional wavelets. Hence, though wavelets may catch the discontinuity across a boundary well, the wavelets cannot characterize the smoothness along the boundary efficiently. Accordingly, in an embodiment, a direction-adaptive transform is applied in a first coding stage to identify and transform any portions of a data block that represent a directional component. The direction-adaptive transform may capture the smoothness along the boundary efficiently.

Examples of direction-adaptive transforms are ridgelets, contourlets, directionlets, wedgelets and bandelets transforms. Direction-adaptive transforms rely on video data that includes some form of “geometry”, such as directional edge information. The directional information may be used to provide better compression, i.e., lower bit rate representations, for two-dimensional piecewise smooth signals that comprise a dominant edge in an image. The direction-adaptive transforms are able to provide better compression than DCT or other singularity transforms. The finite ridgelet transform (FRIT) is one kind of discrete implementation of a ridgelet transform for a finite-size image data block, which effectively compresses line singularities for a number of directions and fits well with the current block-based hybrid video coding architecture.

In the second stage of the two-stage coding, another transform, such as DCT, is used to transform the remaining data in the data block, such as data that is determined not to represent a directional component. Thresholding coefficients computed from applying the direction-adaptive transform in the first stage may be performed to identify any portion of the data block that represents a directional component.

In some situations, such as for portions of data blocks not representing a directional component, direction-adaptive transforms may be less efficient at compression than DCT. Thus, DCT may be used for transforming those portions of the data block in the second stage. Instead of DCT, other types of known transforms may be used in the second stage.

One-stage coding, which uses a single transform instead of multiple transforms, may be used instead of two-stage coding. According to an embodiment, bit rates for one-stage coding and two-stage coding a data block are compared. The transform coding scheme that has the smallest bit rate, such as the smallest number of bits to represent the data block, may be selected for coding the data block. This process is repeated for each data block of the video data. Bit rates may be a function of quantization step size. If different quantization step sizes for one-stage coding and two-stage coding are used, the bit rates may be normalized before they are compared. Also, instead of only comparing bit rates, multiple metrics may be considered when selecting either the one-stage coding or two-stage coding. For example, bit rate and distortion may be considered and the coding technique that achieves the best combination of bit rate and distortion may be selected.

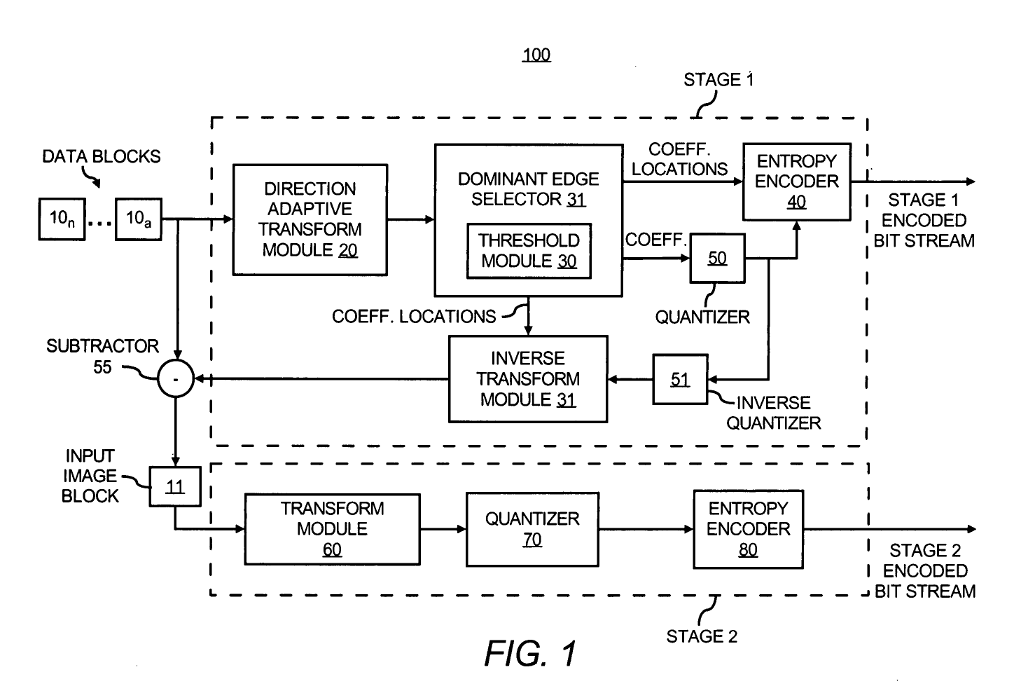

FIG. 1 illustrates a two-stage encoder 100, according to an embodiment. Data blocks 10a-n are data input for the transform 100. The data blocks 10a . . . n may include data blocks of video data. In one example, the data blocks 10a-n are blocks of pixels, such as a MB, in a residual frame.

A direction-adaptive transform module 20 applies a direction-adaptive transform to transform, for example, the data block 10a and subsequent data blocks as shown. In one embodiment, the transform module 20 applies a FRIT to the data block 10a to determine the coefficients for the data block. As described above, FRIT is a ridgelet transform for a finite-size image data block, which effectively compresses line singularities for a number of directions. The FRIT is also invertible. Other types of direction-adaptive transforms may also be used. As is known in the art, FRIT may use a finite radon transform (FRAT) and wavelets to construct ridgelets in the FRIT domain. FRAT is used to compute a summation of image pixels along a set of lines with different directions. Then, ridgelets in the FRIT domain are constructed as the application of one-dimensional wavelets on slices of the Radon transform.

As is known in the art, the computational results of applying the FRIT or another directional-adaptive transform to the data block 10a includes a set of coefficients representing transformed pixels in the data block. For example, N×N coefficients are generated for an N×N block of pixels in the data block 10a.

A directional component selector 31 identifies pixels representing a directional component. The directional component selector 31 may include a threshold module 30 that compares the coefficients calculated by the direction-adaptive transform module 20 to a threshold to identify any directional components in the image represented by the data block 10a. For example, if a coefficient is greater than a threshold, than the threshold module 30 determines the corresponding pixel represents a directional component. The coefficients greater than the threshold are quantized by the quantizer 50. The quantized coefficients and their locations are coded by the entropy encoder 40. The output of stage 1 is a coded bit stream representing one or more directional components in the data block 10.

According to an embodiment, the threshold module 30 compares coefficients to a threshold, T. For example, the threshold T may be defined as T=cq, where q is the quantization step and c is a constant greater than 1. If any coefficients are greater than the threshold, these coefficients are quantized and entropy coded to generate a bit stream output from stage 1 representing any directional components in the data block 11. The number of coefficients greater than the threshold controls the size of the bit rate. The greater the number of coefficients that exceed the threshold, the greater the bit rate for the bit stream output by stage 1 of the two-stage encoder 100.

The value of c and the threshold T is constant in one embodiment. In another embodiment, the threshold T is optimized. For example, the threshold T may be optimized to achieve the best combination of bit rate and distortion for one or more of the bit streams output by the two-stage encoder 100. In one embodiment, the value of c is optimized to optimize the threshold T. For example, the value of c may be optimized so that the combined bit stream output from stage 1 and stage 2, which is described in further detail below, has the smallest bit rate for a given amount of average distortion. The value of c may be transmitted in the combined bit stream for reconstructing the image. The average distortion is determined by the quantization step size qt used in the second transform stage. It should be noted that this formulation for c may be for a single stage case because if a value of c is selected that is larger than all the coefficients, then stage 1, which uses the directional-adaptive transform in the module 20, is not used.

The portions of the data block 10 determined not to represent a directional component by the threshold module 30 are coded using a second transform, such as DCT, in the second stage. The blocks of the portions of the data block 10 determined not to represent a directional component are subtracted from the data block 10. For example, the inverse quantizer 51 inverse quantifies the quantized coefficients greater than the threshold. The inverse transform module 31, which uses a transform that is an inverse of the transform used by the transform module 20, inverse transforms the coefficients to reconstruct the portions of the data block 10 representing a directional component. The reconstructed portions are subtracted from the data block 10 by the subtractor 55 to obtain an input data block 11 for the second stage. In the second stage, the input data block 11 is transformed by the transform module 60 and quantized by the quantizer 70. The quantized coefficients may be entropy coded by the entropy encoder 80. The output of stage 2 is a coded bit stream representing the non-directional components in the data block 10.

The components of the two-stage coding system 100 may include software. For example, one or more of the transform modules 20 and 60, the quantizers 50 and 70, the inverse quantizer 51 and the inverse transform module 60, subtractor 55 and encoders 40 and 80 may include software running on hardware components in a computer system, such as a processor or other circuits. Alternatively, one or more of the components may be comprised of hardware or a combination of software and hardware.

One-stage coding, which uses a single transform instead of multiple transforms, may be used instead of two-stage coding. According to an embodiment, bit rates and distortions for one-stage coding and two-stage coding a data block are compared. The transform coding scheme that has the best combination of bit rate and distortion may be selected for coding the data block.

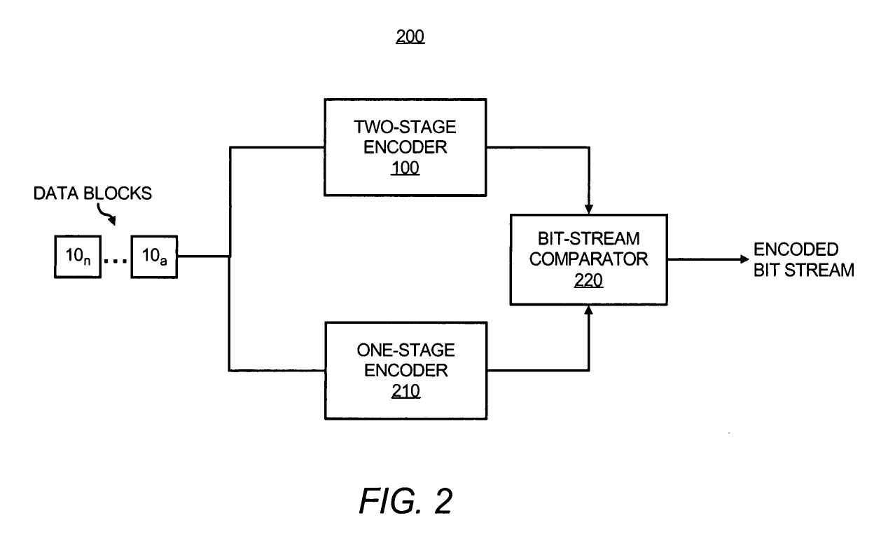

FIG. 2 illustrates a system 200 for coding data blocks. Data blocks 10a-n are input into the two stage coder 100, which may be the two-stage coder 100 shown in FIG. 1, and the one-stage coder 210. The one-stage coder 210 may use the same transform and components that are used in the second stage of the two-stage coder 100 shown in FIG. 1. In one embodiment, instead of having two separate coders for the one-stage coder 210 and the two stage coder 100, the one-stage coder 210 may be the transform module 60, the quantizer 70 and the entropy encoder 80 of the second stage of the two-stage encoder 100.

A bit stream comparator 220 compares the bit streams output by the two-stage encoder 100 and the one-stage encoder 210 to select one of the bit streams. According to an embodiment, a bit stream is selected based on bit rate and distortion. It will be apparent to one of ordinary skill in the art that other metrics may be used to compare the bit streams or one of the metrics, bit rate or distortion may be used. The bit rate may be the number of bits used to code one or more data blocks or a portion of a data block, such as bits per pixel. Also, the bit stream from the two-stage coder 100 may comprise two bit streams, one from stage 1 and one from stage two that are combined into a single bit stream. The bit rate and distortion of the combined bit stream may be compared to the bit rate and distortion of the bit stream output by the one-stage encoder 210. The selected bit stream may be stored on a computer readable medium, such as a DVD or another medium for distribution along with bit streams for other data blocks, or transmitted to another device. For example, the bit streams may be used for streaming video.

A rate-distortion criterion may be used to determine the optimal coding strategy between the one-stage or two-stage coding. In particular, a Lagragian metric J=D+λ×R may be minimized, where D is the distortion achieved after coding, which may be for one-stage or two-stage coding, R is the bit rate, and λ is a predetermined Lagragian parameter constant, which may operate as a weighting factor for bit rate. In most general terms, D should be written as D(x, q, c, qt)—a function of x (the block), q the quantization stepsize of the directional transform, the parameter c, and qt the quantization step size of the singularity transform. R should be correspondingly written as R(x, q, c, qt). The Lagragian metric is then written as J(x, q, c, qt). As discussed above with respect to two-stage coding, the threshold T may be optimized, such as for both rate and distortion. The Lagragian metric may also be used for optimizing the threshold T, and all three parameters q, c, and qt can be optimized so that the optimal coding is achieved. To simplify matters, qt can be held fixed and only q and c may be optimized for the minimum metric, or both q and qt can be held fixed, and only c can be optimized for the minimum metric.

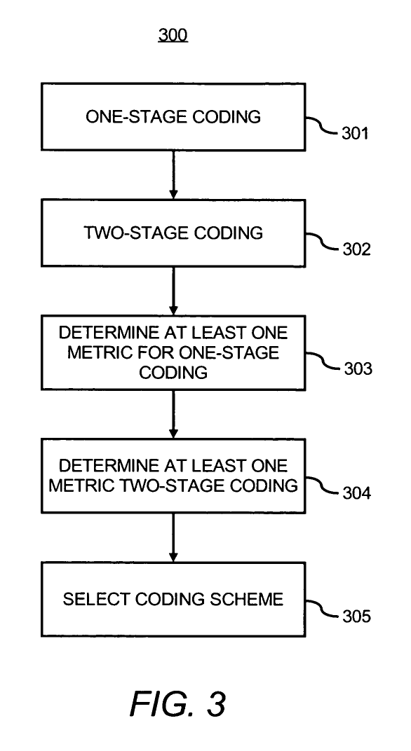

FIG. 3 illustrates a flow chart of a method 300 for optimizing video coding. The method 300 is described with respect to FIGS. 1 and 2 by way of example and not limitation. The method 300 may be performed on encoding systems other than shown in FIGS. 1 and 2.

At step 301, the one-stage coder 210 shown in FIG. 2 codes a data block, such as the data block 10, of video data using a first transform. The coding may include compressing the data block using a first transform, quantizing and coding, such as entropy coding, the quantized data block. A transform, such as DCT, is applied to the data block for compression.

At step 302, the two-stage coder 100 shown in FIGS. 1 and 2 codes the data block using a direction-adaptive transform and the first transform. For example, the two-stage coder 100 codes directional components in the data block, if any, using the direction-adaptive transform and codes the non-directional components using the first transform.

At step 303, the bit stream comparator 220 shown in FIG. 2 determines at least one metric for the bit stream output by the one-stage coding performed at step 301. The one-stage coding may include quantizing using a predetermined Q-factor. The Q-factor determines the quantization steps for DCT transform coefficients. For example, higher Q-factors result in finer quantization steps used by the quantizer in the one-stage coder.

At step 304, the bit stream comparator 220 determines at least one metric for the bit stream output by the two-stage coding performed at step 302. The same or similar Q-factors may be used for one-stage and two-stage coding.

At step 305, the bit stream comparator 220 selects the one-stage coding or the two-stage coding to code the data block based on the determined metrics. For example, bit rates may be compared. Instead of only comparing bit rates, in one embodiment, a function is used to calculate a value based on the bit rate and distortion for each of the coding schemes. The Lagragian function described above is one example of a function that may be used. The Lagragian metric calculated for each coding scheme are compared, for example, to select the bit stream that achieves the best combination of bit rate and distortion. For example, if the two-stage encoding has a slightly smaller bit rate but a much larger distortion when compared to the single-stage encoding, the single stage encoding may be selected. The selected bit stream may be stored and/or transmitted to another device.

It will be apparent to one of ordinary skill in the art that the steps of the method 300 may be performed in orders other than shown in FIG. 3. Also, one or more steps may be performed at the same time.

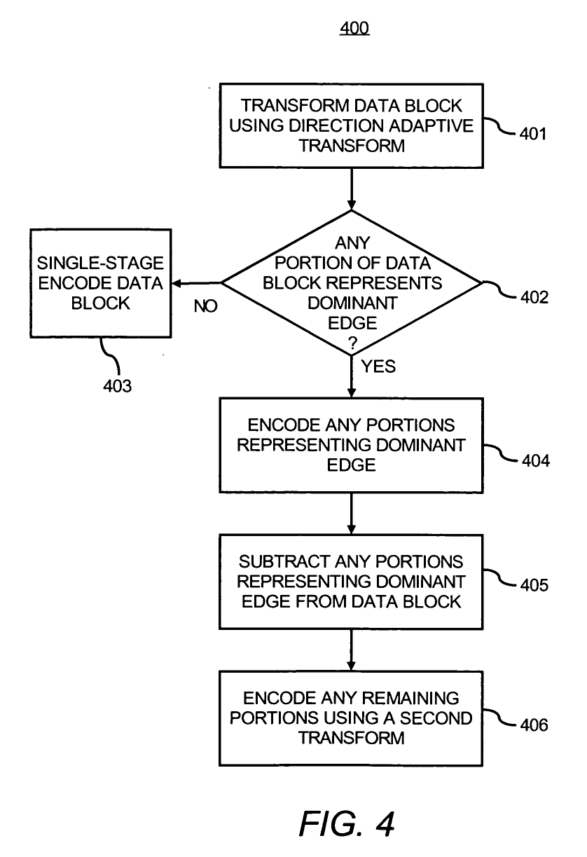

FIG. 4 illustrates a method 400 for two-stage encoding, according to an embodiment. The method 400 is described with respect to the two-stage coder 100 shown in FIG. 1 by way of example and not limitation.

The method 400 may be performed with other types of multi-stage encoders. Also, the steps of the method 400 may be performed at step 302 of the method 300.

At step 401, the two-stage encoder 100 transforms a data block, such as the data block 10a, using a directional adaptive transform. For example, the directional adaptive transform module 20 shown in FIG. 1 applies a directional adaptive transform to the data block 10a. If the directional adaptive transform is a FRIT, first the data block 10a is converted to the Radon domain using a FRAT, and then a FRIT is applied. For example, given that p in equation 1 above is a prime number in the FRAT, a 16×16 MB data block is first extended to 17×17 by replicating the last pixel in an additional row and column. Then an orthogonal FRIT is applied to the resulting block. The directional adaptive transform module 20 determines a set of coefficients and their locations, e.g., corresponding to pixel locations, as a result of applying the directional adaptive transform.

At step 402, the two-stage encoder 100 determines whether any portion of the data block 10a represents a directional component. This may include the threshold module 30 determining whether any coefficients are greater than a threshold. For example, the absolute value of the FRIT coefficients are compared to a threshold T=cq, where q is the quantization step and c is a constant greater than 1. If any coefficients are greater than the threshold, these coefficients are quantized and entropy coded to generate a bit stream output from stage 1 representing any directional components in the data block 11. The threshold, T, may be optimized to produce the lowest bit rate bit stream from stage 1.

If none of the portions of the data block 10 represent a directional component, the data block 10a is single-stage encoded, for example, using DCT, at step 403. Stage 2 of the two-stage encoder 100 may perform the single stage encoding.

At step 404, for any portions of the data block 10 determined to represent a directional component, these portions are encoded. At step 405, any portions of the data block 10 determined to represent a directional component are subtracted from the initial data block 10a, and the remaining input image block 11 is single stage encoded at step 406, for example, using DCT to generate the bit stream output from stage 2.

It will be apparent to one of ordinary skill in the art that the steps of the method 400 may be performed in orders other than shown in FIG. 4. Also, one or more steps may be performed at the same time. Also, the steps of the methods 300 and 400 may be repeated to encode several data blocks, for example, in multiple frames of video data.

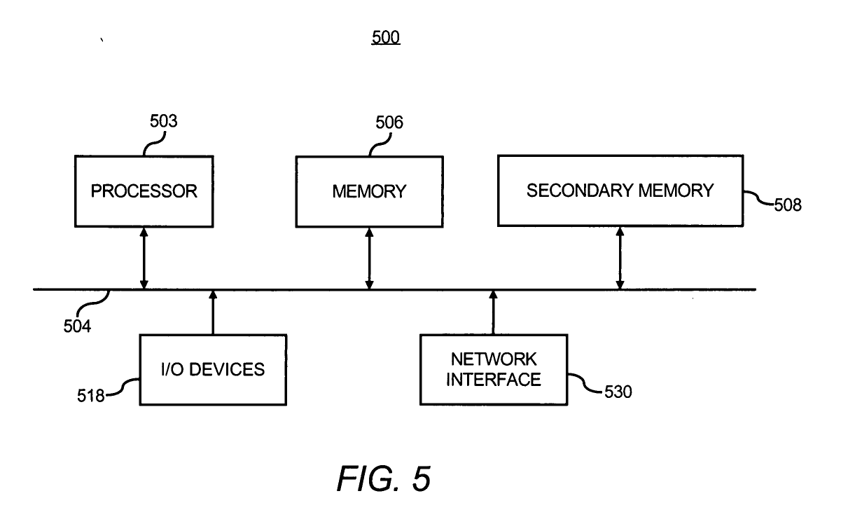

FIG. 5 illustrates an example of a hardware platform for executing the two-stage encoder 100 and the system 200 described above. The computer system 500 may be used as the hardware platform for the encoders and systems described above. The computer system 500 includes one or more processors, such as processor 503, providing an execution platform for executing software. Commands and data from the processor 503 are communicated over a communication bus 504. The computer system 500 also includes a main memory 506, such as a Random Access Memory (RAM), where software may be resident during runtime, and a secondary memory 508. The secondary memory 508 includes, for example, a hard disk drive or other type of storage device. The secondary memory 508 may also include ROM (read only memory), EPROM (erasable, programmable ROM), EEPROM (electrically erasable, programmable ROM).

The computer system 500 may include one or more input/output (I/O) devices 518, such as a keyboard, a mouse, a stylus, display, and the like. A network interface 530 is provided for communicating with other computer systems. The bit streams generated by the two-stage encoder 100 or the system 200 may be transmitted via the network interface 530 to other computer systems. Also, the bit streams may be stored in one or more of the memories 506 and 508. It will be apparent to one of ordinary skill in the art that the computer system 500 more or less features depending on the complexity of system needed for running the classifiers.

One or more of the steps of the methods 300 and 400 and other steps described herein may be implemented as software embedded on a computer readable medium, such as the memory 504 and/or 508, and executed on the computer system 500, for example, by the processor 503.

The steps may be embodied by a computer program, which may exist in a variety of forms both active and inactive. For example, they may exist as software program(s) comprised of program instructions in source code, object code, executable code or other formats for performing some of the steps. Any of the above may be embodied on a computer readable medium, which include storage devices and signals, in compressed or uncompressed form.

Examples of suitable computer readable storage devices include conventional computer system RAM (random access memory), ROM (read only memory), EPROM (erasable, programmable ROM), EEPROM (electrically erasable, programmable ROM), and magnetic or optical disks or tapes. Examples of computer readable signals, whether modulated using a carrier or not, are signals that a computer system hosting or running the computer program may be configured to access, including signals downloaded through the Internet or other networks. Concrete examples of the foregoing include distribution of the programs on a CD ROM or via Internet download. In a sense, the Internet itself, as an abstract entity, is a computer readable medium. The same is true of computer networks in general. It is therefore to be understood that those functions enumerated below may be performed by any electronic device capable of executing the above-described functions.

While the embodiments have been described with reference to examples, those skilled in the art will be able to make various modifications to the described embodiments without departing from the scope of the following claims and their equivalents.

What is claimed is:

1. A method of optimizing video coding, the method comprising:
one-stage coding a data block of video data using a first transform;
two-stage coding the data block using a second direction-adaptive transform and the first transform,
determining a first number of bits used to code the data block by the one-stage coding and a distortion of the one-stage coded data block;
determining a second number of bits used to code the data block by the two-stage coding and a distortion of the two-stage coded data block;
selecting the one-stage coding or the two-stage coding to code the data block based on a comparison of the first number of bits and the distortion of the one-stage coded data block to the second number of bits and the distortion of the two-stage coded data block.

2. The method of claim 1, further comprising:
calculating a value for the one-stage coding as a function of the first number of bits and the distortion of the one-stage coded data block;
calculating a value for the two-stage coding as a function of the second number of bits and the distortion of the two-stage coded data block;
comparing the values; and
selecting the one-stage coding or the two-stage coding to code the data block further comprises selecting the one-stage coding or the two-stage coding to code the data block based on the comparison of the values.

3. The method of claim 1, wherein two-stage coding the data block comprises:
applying the direction-adaptive transform to the data block;
determining whether at least a portion of the data block represents a directional component based on results of applying the direction-adaptive transform to the data block;
in response to determining the least a portion of the data block represents the directional component, coding the least a portion of the data block that represents the directional component;
applying the first transform to any portion of the data block determined not to represent the directional component; and
coding the portion of the data block determined not to represent the directional component.

4. The method of claim 3, wherein determining whether at least a portion of the data block represents a directional component in the video comprises:
comparing coefficients generated from applying the direction-adaptive transform to the data block to a threshold; and
determining whether to select at least one of the coefficients based on the comparison to the threshold.

5. The method of claim 4, wherein two-stage coding the data block comprises:
quantizing a selected at least one coefficient;
entropy coding a location and value for each selected at least one coefficient;
dequantizing the entropy coded location and value for each selected at least one coefficient;
inverse transforming the dequantized entropy coded location and value for each selected at least one coefficient to reconstruct an image block in the video data;
subtracting the reconstructed image block from an original residual image block comprised of the data block to obtain an input image block for a second stage of the two-stage coding; and
applying the first type of transform to the input image block.

6. The method of claim 4, further comprising:
selecting at least one of the coefficients having a value greater than or equal to the threshold.

7. The method of claim 4, further comprising:
optimizing the threshold to achieve the best bit rate and distortion combination.

8. The method of claim 1, wherein the first transform is a DCT transform or an approximation to the DCT transform.

9. The method of claim 1, wherein the direction-adaptive transform is a finite ridgelet transform.

10. A video encoder comprising:
a direction-adaptive transform module operable to apply a direction-adaptive transform to a data block of video data;
a directional component selector operable to determine whether a directional component is included in an image represented by the data block;
a first encoder operable to generate a first bit stream by coding a transformed portion of the data block determined to include the directional component;
a subtractor operable to subtract the portion of the data block determined to include the directional component from an original image represented by the data block to generate an input image block;
a second transform module operable to apply a second transform to the input image block; and
a second encoder operable to generate a second bit stream by coding the transformed input image block.

11. The video encoder of claim 10, further comprising:
a first quantizer quantizing the transformed portion of the data block determined to include the directional component prior to coding.

12. The video encoder of claim 10, further comprising:
a second quantizer quantizing the transformed input image block prior to coding.

13. The video encoder of claim 10, further comprising:
a single-stage encoder operable to transform the data block using the second transform and code the transformed data block to generate a third bit stream.

14. The video encoder of claim 13, further comprising:
a bit stream comparator operable to compare a bit rate and distortion of the third bit stream to a bit rate and distortion of a combined bit stream comprised of the first and second bit streams to select the third bit stream or the combined bit stream to be used as compressed data for the data block.

15. The video encoder of claim 10, wherein the directional component selector comprises:
a threshold module operable to identify coefficients from the direction-adaptive transformed data block that are greater than or equal to a threshold.

16. The video encoder of claim 15, wherein the threshold is optimized to achieve the best bit rate and distortion combination.

17. The video encoder of claim 10, wherein the second transform is a DCT transform or an approximation of the DCT transform.

18. The video encoder of claim 10, wherein the direction-adaptive transform is a finite ridgelet transform.

19. A computer readable medium storing software that when executed by computer hardware performs a method comprising:
one-stage coding a data block of video data using a first transform;
two-stage coding the data block using a second direction-adaptive transform and the first transform,
determining a first number of bits used to code the data block by the one-stage coding and a distortion of the one-stage coded data block;
determining a second number of bits used to code the data block by the two-stage coding and a distortion of the two-stage coded data block;
selecting the one-stage coding or the two-stage coding to code the data block based on a comparison of the first number of bits and the distortion of the one-stage coded data block to the second number of bits and the distortion of the two-stage coded data block.

20. The computer readable medium of claim 19, wherein two-stage coding the data block comprises:
applying the direction-adaptive transform to the data block;
determining whether at least a portion of the data block represents a directional component based on results of applying the direction-adaptive transform to the data block;
in response to determining the least a portion of the data block represents the directional component, coding the least a portion of the data block that represents the directional component;
applying the first transform to any portion of the data block determined not to represent the directional component; and
coding the portion of the data block determined not to represent the directional component.
